(19) United States
(12) Patent Application Publication
(10) Pub. No.: US 2011/0297712 A1
(43) Pub. Date: Dec. 8, 2011

(54) LOCKING MEMBER AND ROOF RACK USING THE SAME

(76) Inventor: JACK C.T. SHEN, Taichung County (TW)

(21) Appl. No.: 12/794,736

(22) Filed: Jun. 5, 2010

(51) Int. Cl. B60R 9/00

(52) U.S. Cl. 224/315

(57) ABSTRACT

The locking member of the present invention includes a main body, at least one engaging portion, a slidable rod and a locking element. The main body defines at least one first bore, at least one chamber and at least one second bore. The chamber communicates the first bore with the second bore. The engaging portion is movably disposed in the chamber, and the engaging portion is formed with a teeth portion adjacent to the first bore. The locking clement includes at least one rod member, which has an engaging end formed with a teeth section. The engaging end is slidably disposed in the first bore. The slidable rod is slidably disposed in the second bore and selectively abuts against the engaging portion so that the teeth portion engages with the teeth section, and the rod member is thus positioned.

### BACKGROUND OF THE INVENTION

1. Field of the Invention

The present invention relates to a luggage rack of a vehicle, and more particularly to roof rack for supporting bicycles.

2. Description of the Prior Art

A typical roof rack of a vehicle for supporting bicycles is as disclosed in TW 459686. The roof rack mainly includes several V-shaped (or U-shaped) slots and a pivotable fastening rod. The V-shaped slots are adapted to support wheels of the bicycles, and the wheels are further tied by several belts. On the other hand, the fastening rod is adapted to clamp and fasten the lower tube of a bicycle. As such, the bicycle can he fastened on the roof rack.

### SUMMARY OF THE INVENTION

The main object of the present invention is to provide a roof rack to tightly fasten bicycle(s) thereon.

To achieve the above and other objects, a locking member is provided to be installed on the roof rack. The locking member includes a main body, at least one engaging portion, a slidable rod and a locking element. The main body defines at least one first bore, at least one chamber and at least one second bore. The chamber communicates the first bore with the second bore. The engaging portion includes an abutting element and a resilient element. The abutting element is movably disposed in the chamber between a first position and a second position. The resilient element abuts against the abutting element and the main body at both ends thereof, such that the abutting element has a potential to return to the first position. The abutting element is formed with a teeth portion locating between the abutting element and the first bore. The slidable rod is slidably disposed in the second bore between a third position and a fourth position. When the slidable rod locates at the third position, the slidable rod abuts against the abutting element so that the abutting element stays at the first position. The locking, element includes at least one rod member, which has an engaging end slidably disposed in the first bore. The engaging end is formed with a teeth section. When the abutting, element locates at the first position, the teeth portion engages with the teeth section so that the rod member is positioned.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a side view showing a roof rack of the present invention;

FIG. 2 is a perspective view showing a roof rack of the present invention;

FIG. 3 is a breakdown drawing showing a roof rack of the present invention;

FIG. 3A is an enlargement drawing showing an abutting shank of the present invention;

FIG. 3B is a profile showing a slidable rod of the present invention;

FIG. 4 is a perspective drawing showing a main body of the present invention;

FIG. 4A is an AA profile of FIG. 4:

FIG. 5 is a profile showing a roof rack of the present invention in which the slidable rod locates at the fourth position;

FIG. 6 is a profile showing a roof rack of the present invention in which the slidable rod locates at the third position.

### DETAILED DESCRIPTION OF THE PREFERRED EMBODIMENTS

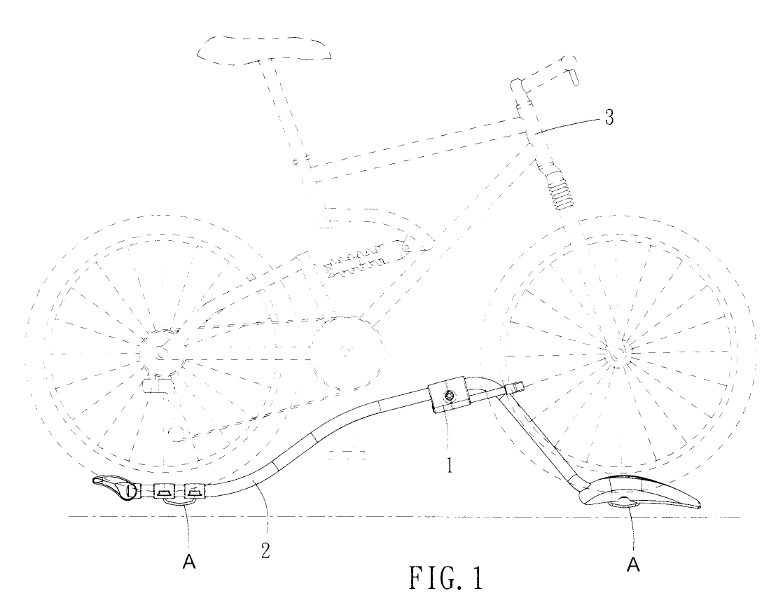

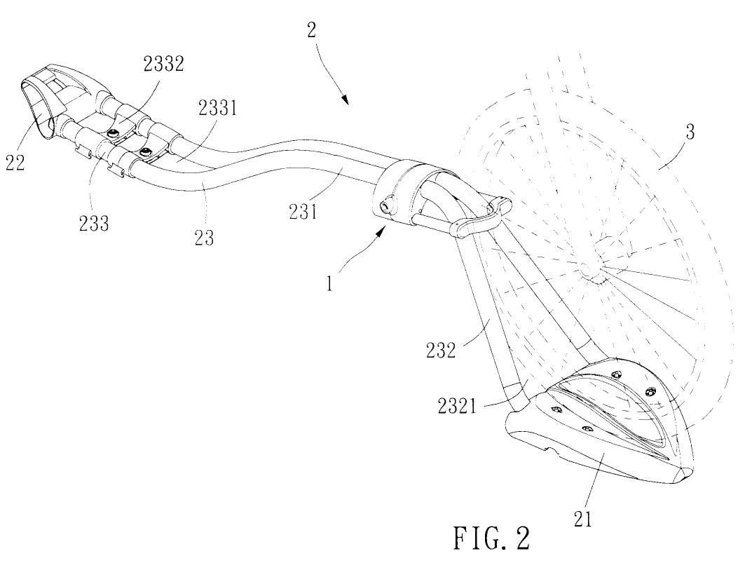

Please refer to FIG. 1 and FIG. 2. A locking member 1 of the present invention is adapted to install on a roof rack 2, so as to position a bicycle 3 on the roof rack. The roof rack 2 further includes a rack member, which includes a front wheel supporter 21, a rear wheel supporter 22 and two tube members 23, each of which has a front end and a rear end. The front wheel supporter 21 is disposed on the front ends of the tube members 23, and the rear wheel supporter 22 is disposed on the rear ends of the tube members 23. The tube members 23 have an abreast section 231 for the main body 1 to dispose thereon. The tube members 23 have a front abutment section 232 extending frontward from the abreast section 231 and split up with each other. The tube members 23 have a curved section extending frontward from the front abutment section for the front wheel supporter 21 to dispose thereon. The front abutment section 232 defines a front positioning space 2321 between the tube members 23 for a front wheel of a bicycle to receive therein. A split joint portion between the front abutment section 232 and the abreast section 231 is adapted to abut against the front wheel. The tube members 23 further have a rear abutment section 233 extending rearward from the abreast section 231 and split up with each other. The rear abutment section 233 defines a rear positioning space 2331 between the tube members 23, and the rear wheel supporter 22 is disposed on a distal end of the rear abutment section 233. Preferably, the rear wheel supporter 22 is curved upward and rearward. At least one supporting clement 2332 can he further laterally disposed across the rear positioning space 2331 and connects to the tube members 23 at both ends thereof. The supporting elements 2332 can be made of soft fabrics, plastics or the like. Thus the supporting elements 2332 and the rear wheel supporter 22 are adapted to support a rear wheel of the bicycle. Two positioning elements A are disposed beneath the supporting clement 2332 and the front wheel supporter 21 respectively so as to fasten the roof rack on a roof of a vehicle.

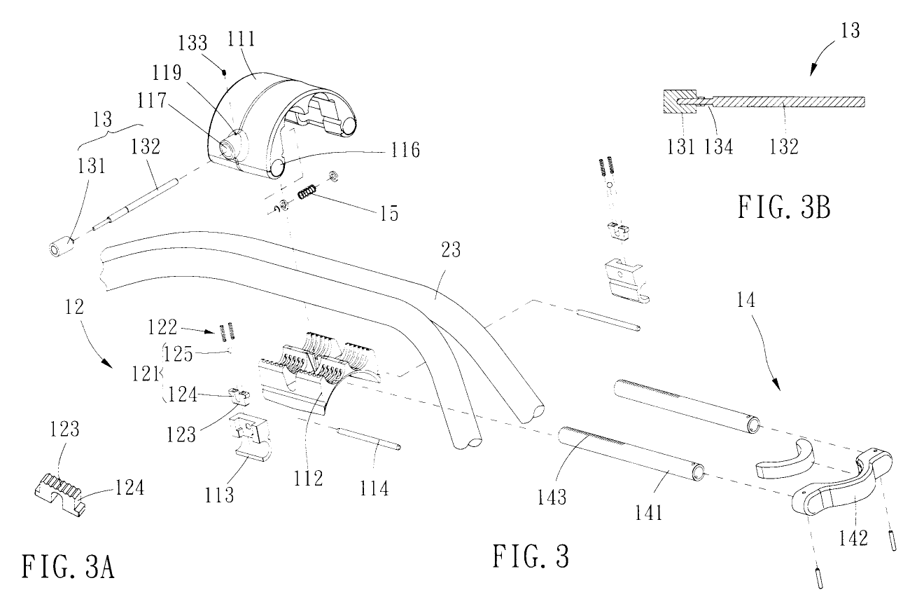

Please refer to FIG. 1 and FIG. 3. The locking member 1 includes a main body, two engaging portions 12, a slidable rod 13, a locking element 4 and a returning device 15.

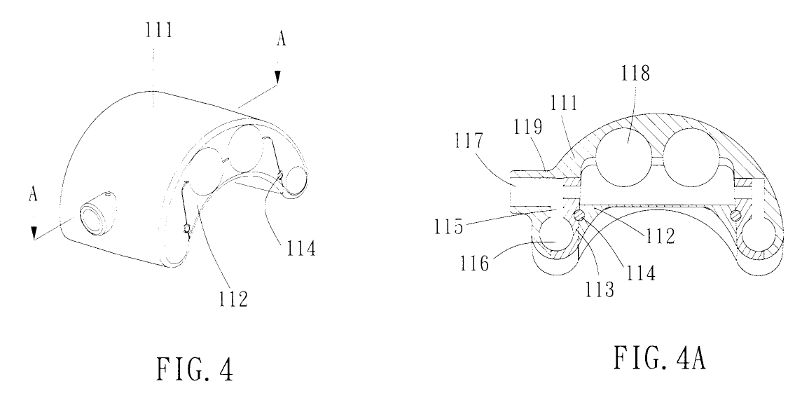

Please refer to FIG. 3, FIG. 4 and FIG. 4A. The main body includes an upper shell 111, a lower shell 112 and two combining shanks 113. The lower shell 112 is fixed on the upper shell 111 with the helps of several screws. The combining shanks 113 are clamped between the upper and lower shells 111 and 112. Two pins 114 are disposed between the combining shanks 113 and the lower shell 112 respectively so as to fix the combining shanks 113. Please refer to FIG. 2 and FIG. 4A. A chamber 115 and a first bore 116 are defined between each combining shank 113 and the upper shell 111, and the chamber 115 communicates with the first bore 116. The upper shell 111 defines a second bore 117 therein, and the second bore 117 communicates with the chamber 115. Two through holes 118 are defined between the upper and lower shells 111 and 112 so as to receive the tube members 23 therein and to position the main body on the rack member. In other possible embodiments of the present invention, the rack member has only one tube member, and only one through hole is defined between the shells to receive the single tube member therein. A positioning bore 119 is further defined in the upper shell 111, and the positioning bore 119 communicates with the second bore 117.

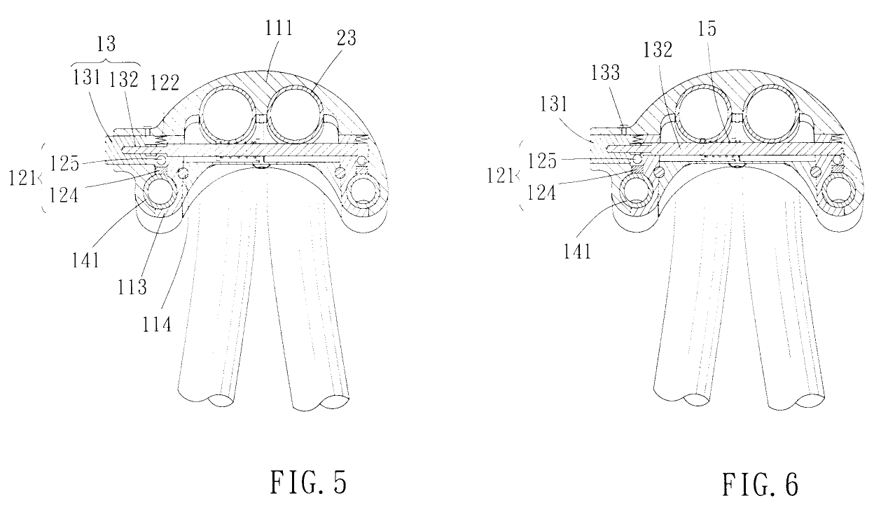

Please refer to FIG. 3, FIG. 4A and FIG. 5. The engaging portions 12 are disposed in the chambers 115 respectively. Each engaging portion 12 includes an abutting element 121 and a resilient clement 122. Each abutting element 121 is movably disposed in the chamber 115 between a first position, which is close to the first bore 116, and a second position, which is remote from the first bore 116. Each abutting element 121 is formed with a teeth portion 123 adjacent to the first bore 116. Preferably, each abutting element 121 includes an abutting shank 124 and a bead 125.

The teeth portion 123 is formed on the abutting shank 124, and thus the abutting shank 124 locates between the teeth portion 123 and the bead 125 as shown in FIG. 3A. Each resilient element 122 includes two springs. Each spring abuts against one of the abutting, elements 121 and the main body at both ends thereof, such that the abutting elements 121 have potential to return to the first position. It is to he noted that the amount of springs can vary in other possible embodiments of the present invention.

The slidable rod 13 includes a head portion 131 and a rod portion 132 extended from the head portion 131. The slidable rod 13 is slidably disposed in the second bore 117 between a third position and a fourth position. Please refer to FIG. 313. The slidable rod 13 is formed with at least one concave notch 134. When the slidable rod 13 locates at the fourth position, the concave notch 134 communicates with one of the chambers 115. The slidable rod 13 can be selectively stopped by a fastening element 133 threadably received in the positioning bore 119.

The locking element 14 includes two rod members 141, each has an engaging end slidably disposed in the first bore 116 and a distal end. A retaining shank 142 is disposed on the distal ends of the rod members 141. Each engaging end is formed with a teeth section 143.

The returning device 15 may he a spring, and the returning device 15 abuts against the main body and the slidable rod 13 at both ends thereof. The returning device 15 provides the slidable rod 13 with a resilience so that the slidable rod 13 has a potential to return to the fourth position. Please refer to FIG. 3, FIG. 4A and FIG. 5. When the slidable rod 13 locates at the fourth position, the abutting elements 121 are not pushed by the slidable rod 13 so that the abutting elements 121 are movable between the first position and the second position. Thus the engaging portions 123 are disengageable from the engaging sections 143. As such, the rod members 141 are slidable with respect to the main body.

Please refer to FIG. 6. When the slidable rod 13 is stopped at the third position by the fastening element 133, the slidable rod 13 pushes the beads 125 so as to locate the abutting elements 121 at the first position. Therefore, the teeth portions 123 engage with the teeth sections 143 respectively, and the rod members 141 are positioned.

Thus the locking element 14 can he used to fasten the bicycle with easily operable rod members. Accordingly the bicycle can he more steadily positioned on the roof rack of the present invention.

What is claimed is:

1. A locking member, comprising
a main body, defining at least one first bore, at least one chamber and at least one second bore, the chamber communicating the first bore with the second bore;
at least one engaging portion, comprising an abutting element and a resilient element, the abutting element being movably disposed in the chamber between a first position and a second position, the resilient element abutting against the abutting element and the main body at both ends thereof, such that the abutting element having a potential to return to the first position, the abutting element being formed with a teeth portion locating between the abutting element and the first bore;
a slidable rod, slidably disposed in the second bore between a third position and a fourth position. wherein when the slidable rod locates at the third position, the slidable rod abuts against the abutting element so that the abutting element stays at the first position:
a locking element, comprising at least one rod member, the rod member having an engaging end slidably disposed in the first bore, the engaging end being formed with a teeth section, wherein when the abutting element locates at the first position, the teeth portion engages with the teeth section so that the rod member is positioned.

2. The locking member of claim 1, wherein the abutting clement comprises an abutting shank and a bead, the teeth portion is formed on the abutting shank, the abutting shank locates between the teeth portion and the bead, when the slidable rod locates at the third position, the bead abuts against the slidable rod.

3. The locking member of claim 1, further comprising a returning device abutting against the main body and the slidable rod at both ends thereof, the returning device providing the slidable rod with a resilience so that the slidable rod having a potential to return to the fourth position.

4. The locking member of claim 1, wherein the slidable rod is formed with at least one concave notch, when the slidable rod locates at the fourth position, the concave notch communicates with the chamber.

5. A roof rack, comprising the locking member of claim 1, and further comprising a rack member, the main body being disposed on the rack member.

6. The roof rack of claim 5, wherein the rack member comprises a front wheel supporter, a rear wheel supporter and at least one tube member, each tube member has a front end and a rear end, the front wheel supporter is disposed on the front ends of the tube members, the rear wheel supporter is disposed on the rear ends of the tube members, the main body defines at least one through hole. the tube member pierces through the through hole so that the main body is fixed on the tube member.

7. The roof rack of claim 6, wherein the rack member comprises two tube members, the tube members have an abreast section for the main body to dispose thereon. the tube members have a front abutment section extending frontward from the abreast section and split up with each other, the tube members have a curved section extending frontward from the front abutment section for the front wheel supporter to dispose thereon, the front abutment section defines a front positioning space between the tube members, the tube members have a rear abutment section extending rearward from the abreast section and split up with each other, the rear abutment section defines a rear positioning space between the tube members, the rear wheel supporter is disposed on a distal end of the rear abutment section.

8. The roof rack of claim 7, wherein at least one supporting element is laterally disposed across the rear positioning space, the supporting element connects to the tube members at both ends thereof, two positioning elements are disposed beneath the supporting element and the front wheel supporter respectively.

9. The roof rack of claim 7, wherein the rear wheel supporter is curved upward and rearward.
